(19) United States
(12) Patent Application Publication
(10) Pub. No.: US 2003/0033612 A1
(43) Pub. Date: Feb. 13, 2003

(54) Software appliance method and system

(76) Inventor: Eddie M. Schwalb, Irvine, CA (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/923,928

(22) Filed: Aug. 7, 2001

(51) Int. Cl. H04N 7/173; H04N 7/16; G06F 3/00; H04N 5/445; G06F 13/00

(52) U.S. Cl. 725/140; 725/134; 725/142; 725/50; 725/132; 725/152

(57) ABSTRACT

A software appliance and method of operation are disclosed that enable distribution of software applications through consumer-electronic appliances, such as set-top boxes. The appliance and method enable the tracking of the software usage for billing purposes. The usage information is sent to the provider of the software so proper accounting may be accomplished. The software applications may be embedded within the software appliance, such as in a datastore or be accessed via a disk reader or other memory devices, such as a memory stick. Each software application is packaged in a signal format that is compatible with the Advanced Television System Committee (“ATSC”) standard 17, also known as the Digital Television Application Software Environment (“DASE”) format. The electronic appliance, or the software appliance, receives a broadcast stream of content information and unpacks the software application carried within the broadcast stream. Next, the appliance converts the software application portion into a usable form so that it can be run on the appliance. As the appliance runs the software, a display system receives a signal illustrating the operation of the software and an application program interface allows the user to interact with the application as viewed on the display system.

### BACKGROUND OF THE INVENTION

The present invention relates generally to a software appliance for providing a host of services to a user on an as-requested basis and, more particularly, to a method and apparatus for providing access to software applications through sources such as computer disks, computer memory sticks, and other application sources and transmitting them through a selected communications port whereby software services and usage are tracked for billing purposes.

The ability to deliver valuable services to a particular location is well-known to those skilled in the art. For example, current valuable services delivered to consumers and business entities include electrical power service, water and sewage services, television services, internet services, and the like. Recent advances have provided the delivery of useful services, such as audio-visual programming in the form of movies, television shows, music packages, and the like, as well as computer useable information typically accessed through an internet connection. The internet connections are often provided via a telephone connection for low speed transmission or via high speed cable or satellite transmission facilities. Content is delivered via the satellite or cable to the consumer or business entity and a translator is provided for descrambling the signal in a manner useful to the consumer or business entity. This is especially so for cable and satellite transmission of audio-video content and computer useable content.

The recent advent of digital television (DTV) for consumer and business use has led to the convergence of cable television programming with that of computer programming and usage. Deployment of DTV software applications transmitted via the cable or satellite system requires the use of centralized servers equipped by application support systems. The operators of such servers are often bound by business relationships that restrict or hamper the distribution of applications that may pose a threat to revenue streams of various organizations participating in the multimedia service hierarchy. For example, software applications that remove commercials are not likely to be approved by operators of application servers, because presenting the commercials is a significant revenue source for these operators.

FIG. 1 illustrates an application distribution method and system in accordance with the prior art. A digital network control server (DNCS) 12 distributes the applications delivered to it by a navigator application server 14, third party application server 16, and an IPG data provider 18. The usage of these applications is a tract, typically for billing purposes, by the DNCS 12 and communicated to a billing system 20. The content is distributed through a cable system 22 to arrive finally at a fiber node or communication port 24, which then connects to a set top box 26, further connected to a television display 28. The STB 26 processes and demodulates the signal to render it viewable on the television monitor 28. In this model, no software application may be used without the consent of the server operator controlling DNCS 12 or without the consent of a cable operator controlling distribution channel 22.

One significant disadvantage of the dependance on the cable distribution channel of FIG. 1 is that the software application vendor who wishes to provide a software-based service cannot distribute its application without entering into a binding relationship with the DNCS operator and the cable operator. Further, the software application vendor must modify the software application to integrate with the application server used by the DNCS operator and the cable operator. Further still, the software application vendor must share revenues with both the server and cable operators.

### SUMMARY OF THE INVENTION

A software appliance and method of operation are disclosed that enable distribution of software applications through consumer-electronic appliances, such as set-top boxes. The appliance and method enable the tracking of the software usage for billing purposes. The usage information is sent to the provider of the software so proper accounting may be accomplished. The software applications may be embedded within the software appliance, such as in a datastore or be accessed via a disk reader or other memory devices, such as a memory stick. Each software application is packaged in a signal format that is compatible with the Advanced Television System Committee (“ATSC”) standard 17, also known as the Digital Television Application Software Environment (“DASE”) format. The electronic appliance, or the software appliance, receives a broadcast stream of content information and unpacks the software application carried within the broadcast stream. Next, the appliance converts the software application portion into a usable form so that it can be run on the appliance. As the appliance runs the software, a display system receives a signal illustrating the operation of the software and an application program interface allows the user to interact with the application as viewed on the display system.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a digital broadband delivery system based on prior art technology;

FIG. 2 illustrates a software appliance in accordance with the present invention; and

FIG. 3 illustrates a method used by the software appliance of FIG. 2 for processing an incoming signal into an enhances signal in accordance with the present invention.

### DETAILED DESCRIPTION OF SPECIFIC EMBODIMENTS

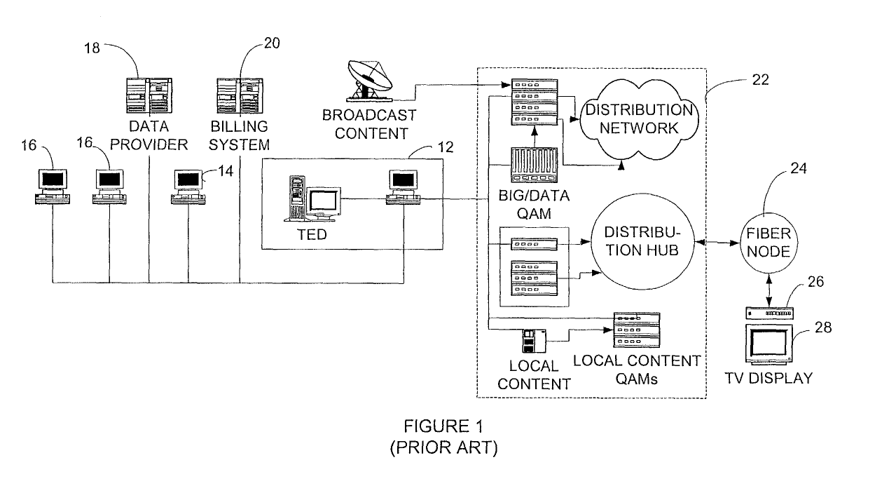

Reference will now be made in detail to the embodiments of the invention, examples of which are illustrated in the accompanying drawings. While the invention will be described in conjunction with the specific embodiments, it will be understood that they are not intended to limit the invention to these embodiments. On the contrary, the invention is intended to cover alternatives, modifications, and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, and components have not been described in detail as not to unnecessarily obscure aspects of the present invention. As such, the following more detailed description of the embodiments of the system and method of the present invention, and represented in FIGS. 1 through 3, is not intended to limit the scope of the invention, as claimed, but is merely representative of specific embodiments of the invention.

The presently defined specific embodiments of the invention will be best understood by reference to the drawings, wherein like parts are designated by like numerals throughout.

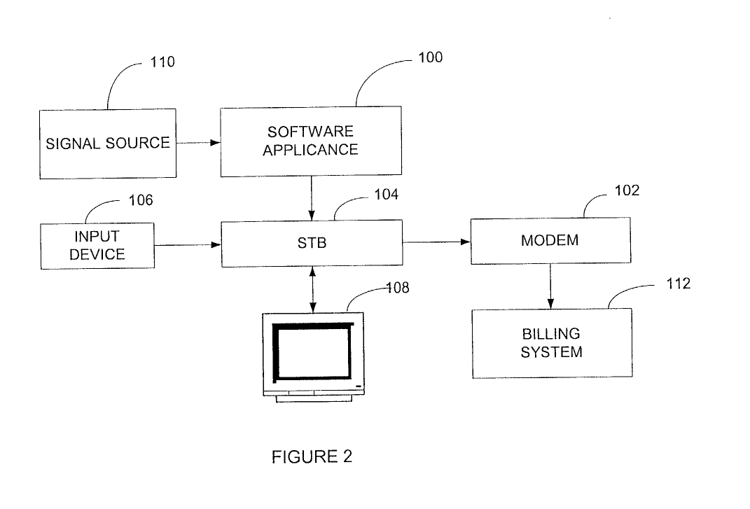

The present invention provides for a software appliance 100, as shown in FIG. 2, that enables the distribution of software applications through consumer electronic appliances. The software appliance 10 also provides for tracking software usage through an internet connection, such as via modem 102, thus offering software to be provided under or within a service business model.

Software applications may be embedded in software appliance 100, which are stored either on a long term memory hard disk system or in long term read only memory. Other software application sources include computer disks or memory sticks where software appliance 100 includes means for reading computer disks such as CD, DVD, floppy disks, and the like or includes means for reading memory sticks or other memory storage means. In one particular embodiment, the software applications are packaged into an Advanced Television Systems Committee (ATSC) S17 DTV Application Software Environment (DASE) signal format that can be retrieved by a DASE-compliant set top box (STB) 104. Such a system is described in U.S. patent application Ser. No. 09/795,720, entitled Content Proxy Method and Apparatus for Digital Television Environment incorporated by reference for all purposes.

STB 104 is able to unpack the application, decipher its signals, execute within a computer environment, and present a graphical user interface (GUI) on a TV display 106 within the ATCS S17 DASE standard specifications. The consumer or TV viewer can then interact with particular software applications loaded in software appliance 100 using a data entry means 106, such as a remote control or a keyboard device, which may be connected directly to software appliance 100 or communicates wirelessly, such as via infrared (IR) signals.

Modem 102 provides an optional internet connection for STB 104 and can be used to transmit HTTP-requests, which are initiated by the application running on STB 104. Further, information based on the tracking of software usage and facilitate billing of such usage by the consumer is transmitted via modem 102 in such a way as to bypass the operator of the application server previously described in FIG. 1. In essence, software appliance 100 operates as a billable high speed local software download appliance that bypasses the cable distribution systems. It should be understood that modem 102 can be of the type that directly connects a personal computer or STB 104 to the services via a telephone line, or can be of the type that connects through a digital signal line (DSL) or other well known connection means available and utilized by those skilled in the art.

The present invention offers several advantages over those of the prior art systems. Specifically, the present invention enables software as a service model that bypasses the application server and cable operators of the prior art. The software, as a service model, enables software to be charged based on download requests or per use monitoring as well. Further, the present invention enables plug and run software available on computer readable media, such as computer disks and DVDs, that are purchased at independent software retailers to be operated on standard NTSC television systems as well as a digital television displays. This provides for a PC-type consumer appliance that has multiple uses other than as a cable tuner, conventional set top box, or stand-alone personal computer not previously available. Another advantage is that the system provides an ATSC S17 DASE broadcast server to be provided within the software appliance, which provides broadcast filtering using local applications and is described in greater detail below. Further, the present invention provides a more elegant and simplified solution in offering software as a service, in stead of server-based, over the cable distribution formats of the prior art.

Several different examples of how the present invention is intended to operate will now be given. Continuing with FIG. 2, the system is intended to operate within a digital application software environment (DASE) for interpreting broadcast information and preparing for presentation on a TV display 108. The DASE broadcast stream, shown as the signal source 110, includes software components called DASE applications that can be run on a client broadcast rendering machine, such as STB 104. Software appliance 100 serves as the signal receiver and accepts and realizes the DASE application from signal source 110. Next, the receiver collects Digital Storage Media Command and Control (DSMCC) data from the transport stream into a Porgram and System Information Protocol (PSIP) database, typically located within software appliance 100 or STB 104. Based on the PSIP information, DASE receiver 100 finds the mapping of the data channel/server service locator to the corresponding physical transport stream or broadcast frequency being sent from signal source 110.

This approach allows the DASE to provide terrestrial and cable broadcasting of applications, which are typically written once by the content providers and are enabled to run on all DASE-compliant STBs. Software appliance 100 generates the transport stream, and hence the application, locally, thereby causing the STB to operate as if the stream was received from the cable operators, but without the need to notify or coordinate with these operators.

Not only does the software appliance 100 manage transport streams from third party service providers, such as satellite and cable operators, but the system can also handle local ATSC signal sources, such as HAVi, 1394, USB, and NTSE output signals, to name but a few. Once an application is downloaded from any of these sources, billing is facilitated by transmitting an HTTP-request via internet modem 102, which is coupled to software appliance 100 and to a billing server. The billing server may be controlled by the software vendor as opposed to the cable operator.

The next model, which is still based on that of FIG. 2, involves a DTV broadcast, whether by terrestrial or cable, that is then augmented by a related local software service, such as one stored on a computer disk. The local software service can provide a function such as selecting portions of the program to be extracted from the whole broadcast. For example, 8 to 10 second intervals consisting of specific football plays may be extracted from a four hour game broadcast. These intervals would correspond to the actual plays rather than the time in between such plays that can be eliminated for purposes of speeding up viewing of the recorded game. This is done by injecting a data service into an existing DTV broadcast. This is known as broadcast filtering. Broadcast filtering either enhances video-only channels by adding data services to the PSIP table or modifies data services PSIP information to include new local data services and exclude unwanted services.

Another mode of operation is referred to as PC replacement mode. In this mode, a computer disk-specific virtual channel is introduced, and may comprise a plurality of such virtual channels. Any one of these channels may be activated when the STB is tuned to them in much the same manner that a television is tuned to a specific channel provided by a VCR or DVD player. This PC replacement mode enables the PC to be replaced as a platform for light consumer applications, such as web browsing, e-mail transactions, word processing letter writing, internet chat or telephony, among others.

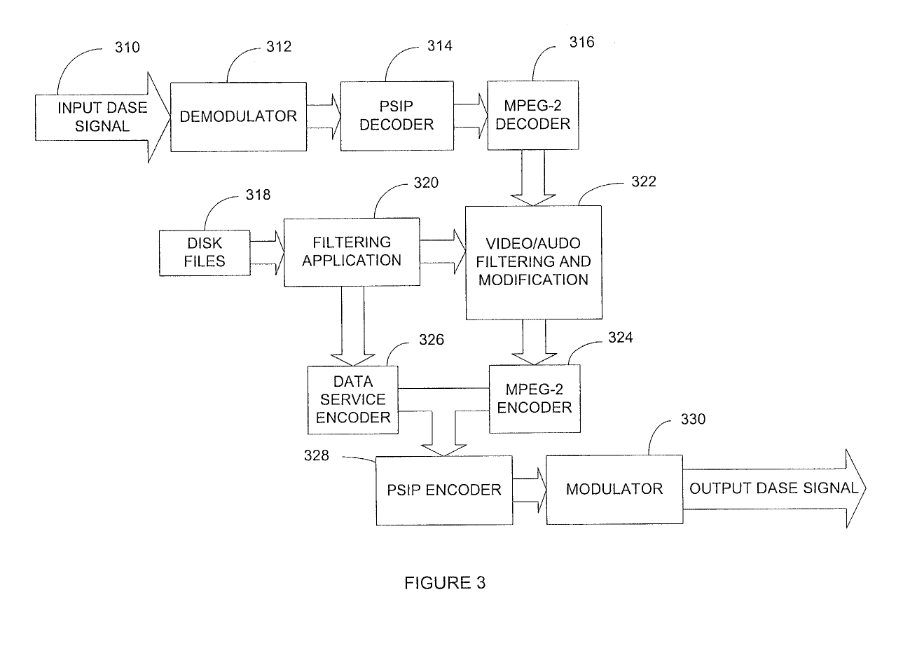

FIG. 3 is a block diagram illustrating a sample process of signal conversion in accordance with the present invention. An original input signal 310 is demodulated at demodulator 312. Next, a PSIP decoder 314 recovers the tables and parses the data stream to extract the broadcast components. These broadcast components include, among others, audio, video, and graphic components, including, but not limited to, software application. The broadcast components fall in an hierarchy of Transport, which includes the subgroups of PSIP (EPG) and Program (PMT). The Program has the subgroups of Video, Audio, and Data Services (DST). The Data Service has one or more Applications, each application comprising a first module, a second module, a data stream, and a trigger stream. Next, an MPEG-2 decoder 316 processes the data and provides access to individual video components. MPEG-2 compression is but one compression scheme utilized for compressing data in digital format where the data typically is multi-media that includes both audio and video components. In this example, the application is originally found on a CD that is read in disk reader 318. The system then filters the application as shown in block 320. The filtering may or may not modify the video portion from MPEG-2 decoder 316. The STB is capable of executing applications embedded in the trasnport. To avoid execution of specific application or modules, such as images, the applications should be filtered-out of the transport. Alternatively, subject to bandwidth constraints certain applications may be replaced by private applications, such as an application originating from a CD or other private resource.

At this point, a video/audio filtering and modification component 322 would perform the optional video modification using any one of several video processing algorithms, one of which is MPEG-2. The modified video is then decoded through MPEG encoder 324. Selected application files are also decoded through data service encoder 326. The decoded video and application are then combined into a unified PSIP database 328. Database 328, as well as the video stream, is modulated via modulator 330 to provide an output DASE signal, which is in the form of ATSC S17 DASE.

It should be understood by those skilled in the art that the various encoders and decoders and filtering means can be implemented in an integrated system executed by a common central processing unit or they may be implemented in discrete programmable processing units, or a combination of the two where multiple functions are handled by one processor and other functions handled by a second or third.

One mode of operation for software appliance 100 from FIG. 2 has software appliance 100 executing the software application and forwarding the graphic user interface display to TV monitor 108 in the form of an NTSC signal, or any other video/audio signal format. A software menu and dialog box are displayed on the video and are in turn controlled by the input device 106, either in the form of IR remote control or IR keyboard. The data input device communicates directly with the software appliance for data input. The input data required by the application may also be uploaded from a hand-held computing device, such as a personal digital assistant (PDA) or a laptop computer. During execution, software usage is tracked by issuing HTTP-requests carried through the internet modem or internet connection to provide billing information to the software developer or commercial manager of the software applications. HTTP-requests may be issued to notify a web-server of an event that occurs during the application execution. For example, a Notification HTTP-request could be sent out when a specific menu option is selected or when a screen is exited, or an application is terminated or any combination thereof.

In an alternative mode, software appliance 100 serves as a display enhancing device whereby graphic display of the PDA or laptop computer, which would provide signal source 110, are redrawn by the graphic drawing functions found within the software appliance and then transmitted to the TV display using the appropriate signal modulation, such as, for example, NTSC, DTV, or high definition (HD) TV. During execution, software usage is tracked still by issuing HTTP requests delivered via the modem to provide billing information to the software developer.

In yet another exemplary embodiment, a plurality of software appliances 100 may be used in what is referred to as a cascading operation mode. In the cascading operation mode, the software appliances may be connected such that the output of the i-th software appliance feeds into the input of the (i+1)-th software appliance. For example, the cable operator may dedicate a first software appliance for filtering or aggregating a broadcast, or both. At this point, only one software appliance is needed regardless of the number of viewers participating within the cable station broadcasts. This provides optimal scalability in that only a single STB or software appliance is necessary to service multiple users. Subsequently, a second location will introduce a second software appliance to provide special services to its participants. For example, a home owner's association or a hotel may use the second software appliance to introduce special services to its residents or guests or to provide special customized services. These services may include advertisement of the local restaurants, providing pay-per-view games or movies, or provide check-out services in the case of hotel or motel. Subsequently, the individual user would then have access to a personal software appliance to run software CDs for performing work or to be entertained by the content stored on the CDs.

Furthermore, at each software appliance stage in the chain, it is possible to connect to another intermediate signal. Thus, the software appliance tree can provide true localization and customization of data services at each software appliance site. For example, a software service provider may charge a cable company for each time a video containing a sporting event is filtered. Similarly, each customer downstream of the cable company who accesses the sporting event on their room software appliance can be billed by the software service provider, independently of the billing model employed by the cable operator.

This provides for a flexible billing chain or tree since independent billing models may be employed at each node within the chain. Further, individual software providers can provide direct billing for the end user when the end user uses non-related applications independent of the cable company or hotel management without the need for coordination between the cable company or the hotel, and without regard to the billing model employed by either.

The software appliance 100 follows certain steps when operating as a software download appliance. This mode, which also includes broadcast-filter and PC-replacement modes, first requires or performs connection of the of the appliance 100 to an application storage device, such as a CD or connect palm pilot, represented as source 110. Next, the appliance reads, analyzes, and encodes application announcement and meta data, which includes the following:

Application identifier

Application Name

Application Description

Application Profile and Level

Application Availability Time and Duration

Application Rating Information

Application Language

Then, the appliance reads, analyzes, and encodes application signaling and meta data, which includes:

Application identifier

Application Profile and Level

Application Invocation Directives

Application Resource Directory

Application Root Entity Resource Identifier

Application Signature

Application Certificates

Following processing of the application signaling and metadata, the appliance reads and analyzes application resources, such as files. For each resource, the appliance encodes the following:

Resource identifier

Resource Content Type

Resource Entity Tag

Resource Cache Directives

Resource Signature

Resource Content

After encoding the resource information, the appliance package this data into an ATSC S13 table structure described in the ATSC A-90 specifications, which also includes DST and related tables. Next, the appliance modulates the tables as a DTV broadcast stream, and transmit to the STB. In this mode, the remote-control signals are directed to the STB running the application. Further, this mode has the advantage of not requiring a complex and expensive high-speed (often 64-bit) application execution CPU, hard-disk and related hardware typically found within a personal computer.

The appliance performs very similarly when operating as a software execution appliance, enables software-as-a-service, as opposed to software download appliance previously discussed. While in software execution appliance mode of operation and control, the appliance connects to the signal source as occurs in the download mode as well as processes the application announcement and meta data, the application signaling and meta data, and perform resource encoding, which is done when in download mode. However, the appliance subsequently identifies the resource marked as the root, executes the root, such as, for example, an Xlet, and then executes the application, which includes converting the graphics into an NTSC or DTV signal for display on the TV display.

In this mode, the user input signals, such as via remote-control, are directed to the software appliance running the application. Further, this mode enables software-as-a-service by tracking of software use. Software use tracking occurs as, at selected execution scenarios, HTTP-requests are generated that are then broadcasted through the modem. Each of these requests includes Software Appliance ID, application ID, Function ID and Time Stamp, which messages can trigger billing transactions.

When operating as a GUI TV display appliance, there is no overlap with either the software download appliance mode or the software execution appliance mode. Instead, the appliance establishes a RemoteMethod Invocation (RMI) link to the pocket appliance, such as a Palm Pilot or similar personal digital assistant devices. Next, the appliance executes drawing function calls originating at the pocket appliance These are used as graphics by the appliance. When the application executes within the pocket appliance, the appliance convert the graphics generated into an NTSC signal and send to the TV for display. In this mode, user input can be entered through an IR keyboard and remote-control signals are directed to the appliance or set top box. These signals are then forwarded to the pocket appliance through the RMI interface through a well known connection such as an USB channel.

To function as a software-as-a-service business model, it is necessary for the software application, via the appliance, to notify a billing server when billable functions are executed. To provide such notification, appliance 100, of FIG. 2, utilizes modem 102 to transport HTTP requests. Initially, each application must define billable functions, with billing entry and optional exit points. When a billing entry point is reached, typically during normal execution of the application, an HTTP-request is sent with the parameters ApplianceID, ApplicationID, FunctionID, a Time Stamp, and Action=StartBilling. This could implemented at start up, via a login tracking mechanism. If no entry point is defined, the default (and only) entry is the start of execution. When a billing exit point is reached during normal execution of the application, an HTTP-request is sent with the parameters ApplianceID, ApplicationID, FunctionID, a Time Stamp, and Action=StopBilling. This could notify a logout mechanism.

Alternatively, the HTTP-request can be transmitted to a server address controlled by the application vendor, such as at www.vendor.com, where vendor is the name of the vendor, and not by the cable operator. Further more, the HTTP-request can be transmitted in an asynchronous manner, which can be achieved by spawning a separate thread, so as to enable execution of the application without waiting for the HTTP-response.

The conversion of the tracking HTTP-requests into billing statements, for example, bill time between StartBilling and EndBilling messages, is the responsibility of the operator of the server to which the HTTP-requests are sent to, such as the software vendor.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A software appliance apparatus for receiving broadcast content information having at least one software application comprising:
a central processing unit;
a memory module contained within said software appliance apparatus and electrically coupled to said central processing unit;
a data structure contained and stored on said memory module, said single reference data structure capable of receiving and storing said broadcast content information, said broadcast content information processed by said central processing unit such that the software appliance apparatus receives the content information and processes the at least one software application therewith;
an application program interface for providing a single unified access interface to the software application, wherein all of said content information is accessed through said application program interface; and
a monitoring and billing module, coupled to the memory module, to monitor activity of the at least one software application and to bill a recipient based on the activity monitored.

2. The software appliance apparatus according to claim 1, wherein the apparatus operates within a Digital TV Application Software Environment (DASE).

3. The software appliance apparatus according to claim 1, wherein the data structure is Program and System Information Protocol (“PSIP”) compatible.

4. The software appliance apparatus according to claim 1, further comprises a disk reader, coupled to the central processing unit, to read content on a source disk and transmit it to the data structure as the broadcast content information.

5. The software appliance apparatus according to claim 1, wherein the software appliance further comprises a personal digital assistant (PDA) device connection for connection to a PDA device enabling the PDA device to access the at least one software application.

6. The software appliance apparatus according to claim 1, further comprising a display, coupled to the application program interface, to display the at least one software application during use.

7. The software appliance apparatus according to claim 1, wherein the broadcast content information is generated within the software appliance locally.

8. The software appliance apparatus according to claim 7, further comprising a set top box, coupled to the data structure, to receive the broadcast content information for rendering on a display device.

9. A method for utilizing broadcast content information having at least one software application, comprising:
receiving a broadcast content information data stream, comprising the at least one software application;
processing the broadcast content information to access the at least one software application;
collecting component data from the broadcast content information data stream;
storing the collected data in a data store;
accessing a data channel identified in the collected data; and
rendering the at least one software application found within the accessed data. channel for display and for utilization by a user.

10. The method according to claim 9, wherein the broadcast content information is based on a Digital TV Application Software Environment (DASE) framework.

11. The method according to claim 9, wherein the data stream is Program and System Information Protocol (“PSIP”) compatible.

12. The method according to claim 9, wherein the broadcast content information data stream receiving step includes the step of reading content on a source disk.

13. The method according to claim 9, further comprising the step of monitoring usage of the at least one software application by the user.

14. The method according to claim 13, further comprising the step of billing the user for the usage of the at least one software application as monitored.

15. A computer-readable code product utilized within a programmable computer environment for utilizing broadcast content information having at least one software application, the product comprising:
computer readable code for receiving a broadcast content information data stream, comprising the at least one software application;
computer readable code for processing the broadcast content information to access the at least one software application;
computer readable code for collecting component data from the broadcast content information data stream;
computer readable code for storing the collected data in a data store;
computer readable code for accessing a data channel identified in the collected data; and
computer readable code for rendering the at least one software application found within the accessed data. channel for display and for utilization by a user.

16. The product according to claim 15, wherein the broadcast content information is based on a Digital TV Application Software Environment (DASE) framework.

17. The product according to claim 15, wherein the data stream is Program and System Information Protocol (“PSIP”) compatible.

18. The product according to claim 15, wherein the broadcast content information data stream receiving code includes computer readable code for reading content on a source disk.

19. The product according to claim 15, further comprising computer readable code for monitoring usage of the at least one software application by the user.

20. The product according to claim 19, further comprising computer readable code for billing the user for the usage of the at least one software application as monitored.

21. A set top box that receives and interprets an audio/video signal for play on an audio/video device and that also receives broadcast content information having at least one software application, the set top box comprising:
a signal receiving input device;
a central processing unit, coupled to the signal receiving input device;
an audio/video translation device, coupled to the signal receiving input device, to convert the audio/video signal for output;
a memory module contained within said software appliance apparatus and electrically coupled to said central processing unit;
a data structure contained and stored on said memory module, said single reference data structure capable of receiving and storing said broadcast content information, said broadcast content information processed by said central processing unit such that the software appliance apparatus receives the content information and processes the at least one software application therewith; and
an application program interface for providing a single unified access interface to the software application, wherein all of said content information is accessed through said application program interface.

22. The software appliance apparatus according to claim 21, wherein the apparatus operates within a Digital TV Application Software Environment (DASE).

23. The software appliance apparatus according to claim 21, wherein the data structure is Program and System Information Protocol (“PSIP”) compatible.

24. The software appliance apparatus according to claim 21, further comprises a disk reader, coupled to the central processing unit, to read content on a source disk and transmit it to the data structure as the broadcast content information.

25. The software appliance apparatus according to claim 21, wherein the software appliance further comprises a personal digital assistant (PDA) device connection for connection to a PDA device enabling the PDA device to access the at least one software application.

26. The software appliance apparatus according to claim 21, further comprising a display, coupled to the application program interface, to display the at least one software application during use.

27. The software appliance apparatus according to claim 21, wherein the broadcast content information is generated within the software appliance locally.

28. The software appliance apparatus according to claim 27, further comprising a monitoring and billing module, coupled to the memory module, to monitor activity of the at least one software application and to bill a recipient based on the activity monitored.
